(19) United States
(12) Patent Application Publication
(10) Pub. No.: US 2018/0004668 A1
(43) Pub. Date: Jan. 4, 2018

(54) SEARCHABLE HOT CONTENT CACHE

(71) Applicant: Intel Corporation, Santa Clara, CA (US)

(72) Inventors: Omid J. AZIZI, Redwood City, CA (US); Alexandre Y. SOLOMATNIKOV, San Carlos, CA (US); Amin FIROOZSHAHIAN, Mountain View, CA (US); John P. STEVENSON, Palo Alto, CA (US); Mahesh MADDURY, San Jose (US)

(21) Appl. No.: 15/199,587

(22) Filed: Jun. 30, 2016

(51) Int. Cl. G06F 12/0846; G06F 12/0804

(52) U.S. Cl. CPC G06F 12/0848; G06F 12/0804; G06F 2212/314; G06F 2212/1024; G06F 2212/608; G06F 2212/282

(57) ABSTRACT

A searchable hot content cache stores frequently accessed data values in accordance with embodiments. In one embodiment, a circuit includes interface circuitry to receive memory requests from a processor. The circuit includes hardware logic to determine that a number of the memory requests that is to access a value meets or exceeds a threshold. The circuit includes a storage array to store the value in an entry based on a determination that the number meets or exceeds the threshold. In response to receipt of a memory request from the processor to access the same value at a memory address, the hardware logic is to map the memory address to the entry of the storage array.

### FIELD

The descriptions are generally related to a searchable content-based cache and more specifically to a searchable hot content cache to store data based on the frequency at which the data values are accessed.

### COPYRIGHT NOTICE/PERMISSION

Portions of the disclosure of this patent document may contain material that is subject to copyright protection. The copyright owner has no objection to the reproduction by anyone of the patent document or the patent disclosure as it appears in the Patent and Trademark Office patent file or records, but otherwise reserves all copyright rights whatsoever. The copyright notice applies to all data as described below, and in the accompanying drawings hereto, as well as to any software described below: Copyright © 2016, Intel Corporation, All Rights Reserved.

### BACKGROUND

With ever-improving designs and manufacturing capability, processors continue to become more capable and achieve higher performance. As processor capabilities increase, the demand for more functionality from devices increases. The increased functionality in turn increases processor bandwidth demand. Traditionally, system memory operates at slower speeds than the processor and typically does not have sufficient bandwidth to take full advantage of the processor's capabilities.

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, and/or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1A is a block diagram of a system including a searchable hot content cache, in accordance with an embodiment.

FIG. 1B is a block diagram of a system including a searchable hot content cache and a searchable memory, in accordance with an embodiment.

FIG. 2A is a block diagram of an architecture including a searchable hot content cache, in accordance with an embodiment.

FIG. 2B is a block diagram of an architecture including a searchable hot content cache and a searchable memory, in accordance with an embodiment.

FIG. 3 is a block diagram of a searchable hot content cache subsystem during performance of a search operation, in accordance with an embodiment.

FIG. 4 is a block diagram of a searchable hot content cache subsystem during performance of a read operation, in accordance with an embodiment.

FIG. 5 is a block diagram of a searchable hot content cache subsystem during performance of a search or read operation, including a determination of whether to perform a fill operation, in accordance with an embodiment.

FIG. 6 is a flow diagram of a process performed by a searchable hot content cache subsystem, in accordance with an embodiment.

FIG. 7 is a flow diagram of a process of performing a search operation in a searchable hot content cache, in accordance with an embodiment.

FIG. 8 is a flow diagram of a process of performing a read operation in a searchable hot content cache, in accordance with an embodiment.

FIG. 9 is a block diagram of an embodiment of a computing system in which a searchable hot content cache can be implemented.

FIG. 10 is a block diagram of an embodiment of a mobile device in which a searchable hot content cache can be implemented.

Descriptions of certain details and implementations follow, including a description of the figures, which may depict some or all of the embodiments described below, as well as discussing other potential embodiments or implementations of the inventive concepts presented herein.

### DETAILED DESCRIPTION

As described herein, a searchable hot content cache can improve system performance by caching frequently accessed values, in accordance with embodiments. In contrast to a conventional cache, which stores frequently accessed memory locations, a searchable hot content cache can store frequently accessed data values. In one embodiment, the hot content cache is searchable. For example, embodiments include circuitry to search the hot content cache to determine if the hot content cache has already cached a given value, and if so, circuitry to map a request for the given value to the hot content cache. Thus, by caching hot data values (e.g., frequently accessed values), a searchable hot content cache can improve system performance by reducing the number of accesses to main memory for frequently accessed values.

In one embodiment, a circuit includes interface circuitry to receive memory requests from a processor. The circuit also includes hardware logic to determine whether a number of the memory requests that is to access a value meets or exceeds a threshold. The circuit further includes a storage array to store the value in an entry based on a determination that the number of requests to access the value meets or exceeds the threshold. In response to receipt of a memory request from the processor to access the same value at a memory address, the hardware logic is to map the memory address to the entry of the storage array.

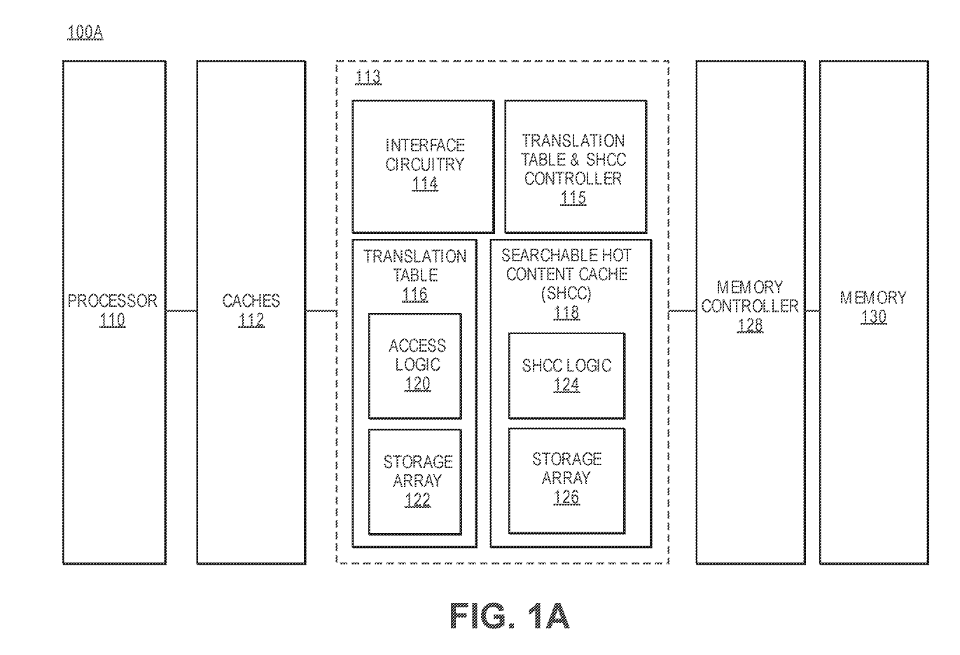

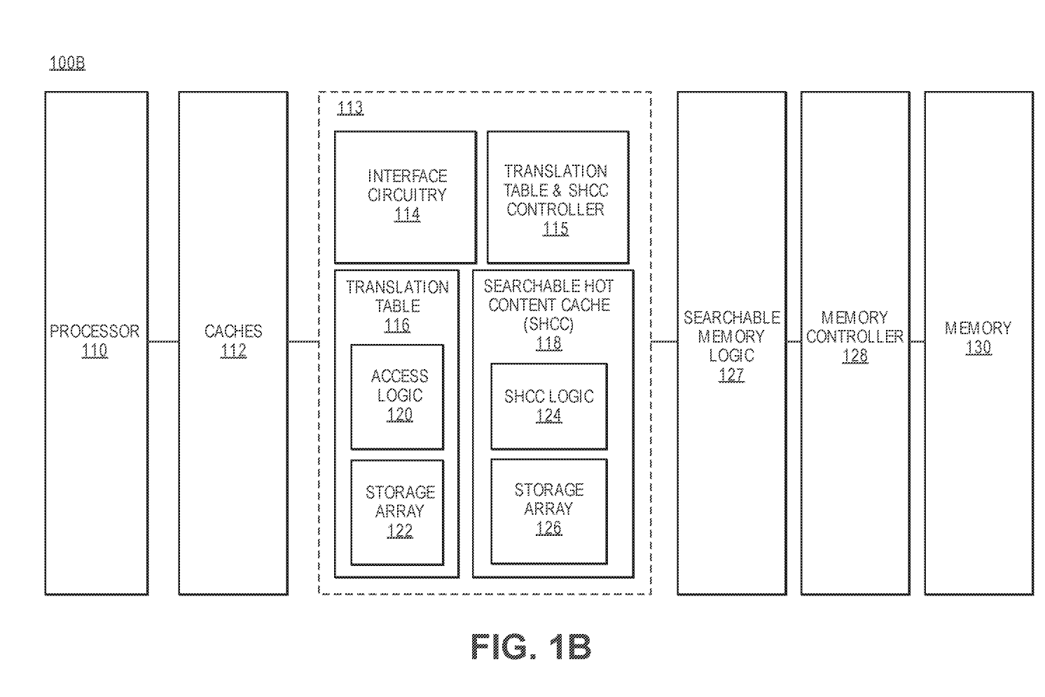

FIG. 1A is a block diagram of a system including a searchable hot content cache, in accordance with an embodiment. FIG. 1B is a block diagram of a system similar to system 100A FIG. 1A, but with the addition of a searchable memory, in accordance with an embodiment.

Turning to FIG. 1A, system 100A includes processor 110 coupled with memory 130. The term “coupled” can refer to elements that are physically, electrically, and/or communicatively connected either directly or indirectly, and may be used interchangeably with the term “connected” herein. Physical coupling can include direct contact. Electrical coupling includes an interface or interconnection that allows electrical flow and/or signaling between components. Communicative coupling includes connections, including wired and wireless connections, that enable components to exchange data. Thus, processor 110 is communicatively coupled with memory 130. Processor 110 represents a processing unit of a host computing platform that executes an operating system (OS) and applications, which can collectively be referred to as a “host” for the memory. The OS and applications execute operations that result in memory accesses. Processor 110 can include one or more separate processors. Each separate processor can include a single and/or a multicore processing unit. The processing unit can be a primary processor such as a CPU (central processing unit) and/or a peripheral processor such as a GPU (graphics processing unit). System 100A can be implemented as an SOC (system on a chip), or be implemented with standalone components. In one embodiment, processor 110, cache 112, searchable hot content cache subsystem 113, and memory controller 128 are integrated onto the same chip. Thus, in one embodiment, searchable hot content cache 118 is to cache frequently accessed values on-die, enabling fast access by processor 110 to the frequently accessed cached content.

Memory 130 represents memory resources for system 100A. Memory 130 can include one or more different memory technologies. In one embodiment, memory 130 includes system memory. System memory generally refers to volatile memory technologies, however, memory 130 can include volatile and/or nonvolatile memory technologies. Volatile memory is memory whose state (and therefore the data stored on it) is indeterminate if power is interrupted to the device. Nonvolatile memory refers to memory whose state is determinate even if power is interrupted to the device. Dynamic volatile memory requires refreshing the data stored in the device to maintain state. One example of dynamic volatile memory includes DRAM (dynamic random access memory), or some variant such as synchronous DRAM (SDRAM). A memory subsystem as described herein may be compatible with a number of memory technologies, such as DDR3 (dual data rate version 3, original release by JEDEC (Joint Electronic Device Engineering Council) on Jun. 27, 2007, currently on release 21), DDR4 (DDR version 4, initial specification published in September 2012 by JEDEC), LPDDR3 (low power DDR version 3, JESD209-3B, August 2013 by JEDEC), LPDDR4 (LOW POWER DOUBLE DATA RATE (LPDDR) version 4, JESD209-4, originally published by JEDEC in August 2014), WIO2 (Wide I/O 2 (WideIO2), JESD229-2, originally published by JEDEC in August 2014), HBM (HIGH BANDWIDTH MEMORY DRAM, JESD235, originally published by JEDEC in October 2013), DDR5 (DDR version 5, currently in discussion by JEDEC), LPDDR5 (currently in discussion by JEDEC), HBM2 (HBM version 2), currently in discussion by JEDEC), and/or others, and technologies based on derivatives or extensions of such specifications.

In addition to, or alternatively to, volatile memory, in one embodiment, reference to memory devices can refer to a nonvolatile memory device whose state is determinate even if power is interrupted to the device. In one embodiment, the nonvolatile memory device is a block addressable memory device, such as NAND or NOR technologies. Thus, a memory device can also include a future generation nonvolatile devices, such as a three dimensional crosspoint memory device, or other byte addressable nonvolatile memory devices. In one embodiment, the memory device can be or include multi-threshold level NAND flash memory, NOR flash memory, single or multi-level Phase Change Memory (PCM), a resistive memory, nanowire memory, ferroelectric transistor random access memory (FeTRAM), magnetoresistive random access memory (MRAM) memory that incorporates memristor technology, or spin transfer torque (STT)-MRAM, or a combination of any of the above, or other memory. Descriptions herein referring to a “DRAM” can apply to any memory device that allows random access, whether volatile or nonvolatile. The memory device or DRAM can refer to the die itself and/or to a packaged memory product.

Memory controller 128 represents one or more memory controller circuits or devices for system 100A. Memory controller 128 represents control logic that generates memory access commands in response to the execution of operations by processor 110. Memory controller 128 accesses one or more memory devices of memory 130. In one embodiment, memory controller 128 includes command logic, which represents logic or circuitry to generate commands to send to memory 130.

System 100A further includes cache 112. Cache 112 includes logic and storage arrays for storing the data at frequently accessed locations. In one embodiment, cache 112 is a cache hierarchy that includes multiple levels of cache. For example, cache 112 can include lower level cache devices that are close to processor 110, and higher level cache devices that are further from processor 110. Processor 110 accesses data stored in memory 130 to perform operations. When processor 110 issues a request to access data stored in memory 130, processor 110 can first attempt to retrieve the data from the lowest level of cache based on the target memory address. If the data is not stored in the lowest level of cache, that cache level can attempt to access the data from a higher level of cache. There can be zero or more levels of cache in between memory 130 and a cache that provides data directly to the processor. Each lower level of cache can make requests to a higher level of cache to access data, as is understood by those skilled in the art. If the memory location is not currently stored in cache 112, a cache miss occurs.

In one embodiment, in the event of a cache miss in cache 112, cache 112 can send the request to searchable hot content cache subsystem 113. Sending a memory request can involve sending some or all of the information (e.g., memory address, data, and/or other information) associated with the request. Searchable hot content cache subsystem 113 includes searchable hot content cache 118. In the embodiment illustrated in FIG. 1A, searchable hot content cache 118 is located in the memory hierarchy after the last-level cache of cache 112 and before system memory 130. In one embodiment, searchable hot content cache 118 is a cache of hot data values. “Hot content” or “hot data values” are frequently read or written data values. Thus, in contrast to a conventional cache that stores data at frequently accessed locations, searchable hot content cache 118 stores data based on the frequency of access of the data values, in accordance with embodiments.

In one embodiment, searchable hot content cache can monitor memory traffic, and fill content into the cache when it detects that the content is hot. For example, hot content cache subsystem 113 includes interface circuitry 114 to receive memory requests from processor 110 (e.g., after a cache miss in cache 112). Circuitry includes electronic components that are electrically coupled to perform analog or logic operations on received or stored information, output information, and/or store information. Subsystem 113 also includes a searchable hot content cache 118. Searchable hot content cache 118 includes hardware logic 124. Hardware logic is circuitry to perform logic operations such as logic operations involved in data processing. Hardware logic 124 is to perform one or more of the operations described herein related to operation of hot content cache 118. For example, described below in further detail, hardware logic 124 includes logic to perform a fill operation, evict operation, a search operation, a read operation, and/or other hot content cache operations, in accordance with embodiments. Thus, in one embodiment, hardware logic 124 includes circuitry to keep track of requested data values and determine whether a given value is hot. In one such embodiment, hardware logic 124 determines whether a number of memory requests that is to access a value meets or exceeds a threshold. If hardware logic 124 determines that a number of memory requests to access the value meets or exceeds the threshold, hardware logic 124 can cache the value by storing the value in an entry of storage array 126. In accordance with an embodiment, a storage array includes a plurality of storage elements such as, for example, registers, SRAM or a DRAM.

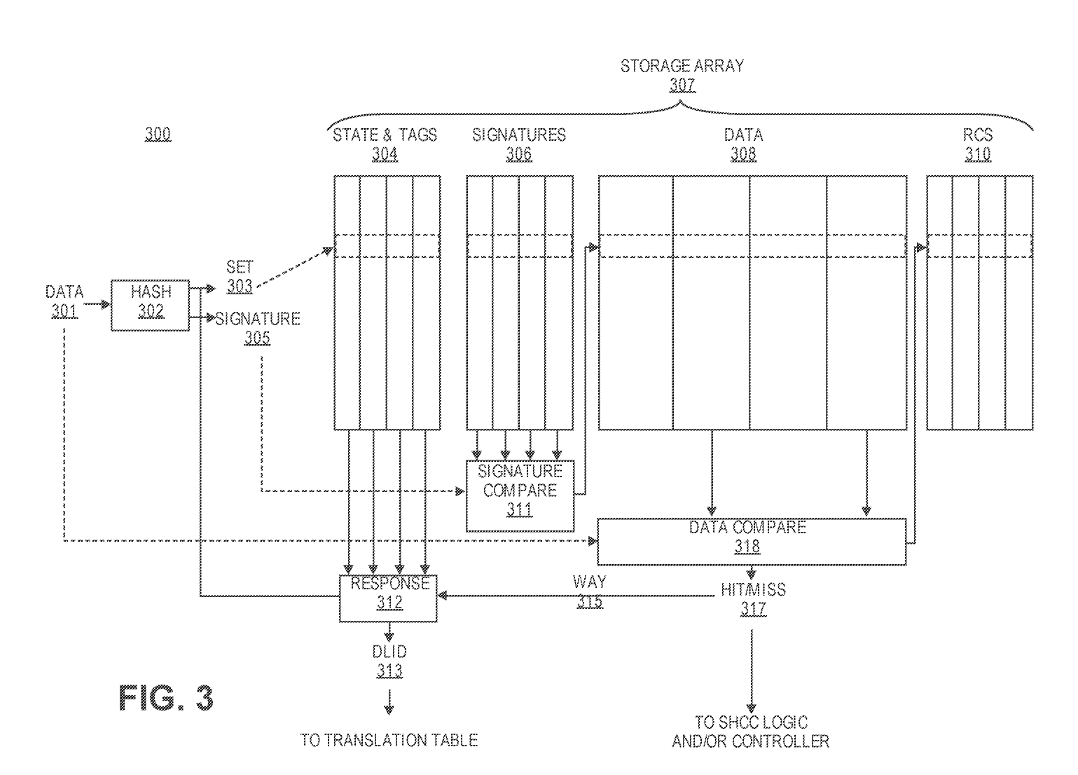

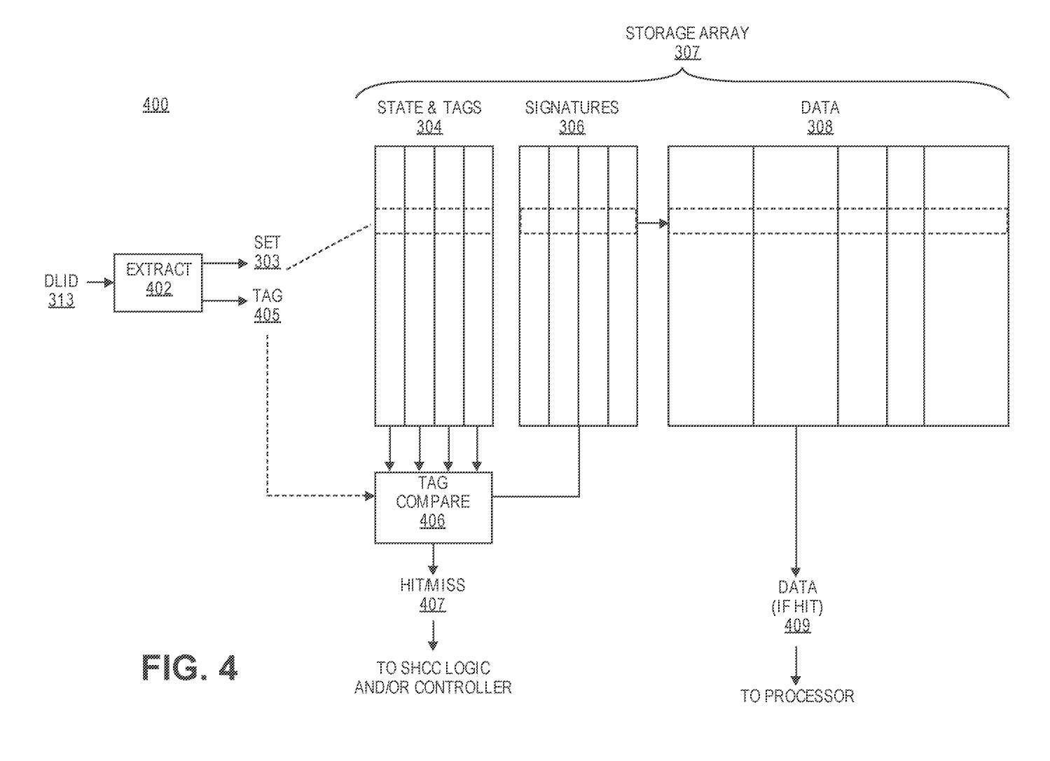

Subsystem 113 also includes a controller 115, in accordance with embodiments. In one embodiment, controller 115 includes circuitry to control the operation of translation table 116 and/or searchable hot content cache 118. For example, in one embodiment, when interface circuitry 114 receives a memory request, interface circuitry 114 can provide information related to the memory request to controller 115. Although a single controller 115 is illustrated in FIG. 1A, control circuitry for translation table 116 and searchable hot content cache may be organized as one or multiple controllers, or can be integrated with other circuitry of subsystem 113. In one example in which interface circuitry 114 receives a memory write request, controller 115 sends the value to be written to hardware logic 124 of searchable hot content cache 118. Hardware logic 124 searches storage array 126 to see if the value to be written already exists in the cache. If the value is already in the cache (a hot content cache hit), logic 124 can map the memory address of the request to the entry of storage array 126 that includes the value. In one embodiment, in order to map the memory address of the request to the entry of storage array 126, logic 124 provides an identifier for the entry of storage array 126 to translation table 116. As described in more detail below with respect to FIGS. 3 and 4, an identifier for an entry of storage array 126 includes information to enable accessing the data value stored in the entry. Thus, in one embodiment, the identifier is a data line identifier (DLID) that points to an entry in storage array 126, enabling access to the data line in the entry. Translation table 116 includes storage array 122 to store memory addresses and identifiers for entries of storage array 126, in accordance with embodiments. In one such embodiment, translation table 116 enables redirection of memory accesses to storage array 126 of hot content cache 118. Storage array 122 can include the same or a similar type of storage elements as storage array 126.

In another example, when interface circuitry 114 receives a memory read request, controller 115 sends the memory address of the request to translation table 116. Access logic 120 of translation table 116 determines whether the memory address is stored in storage array 122. In one embodiment, if access logic 120 determines that a given memory address is found in storage array 122, the content at the memory address is stored in storage array 126 of searchable hot content cache 118. Thus, in one such embodiment, access logic 120 reads the identifier associated with the memory address from storage array 122. Translation table 116 can then provide the identifier to searchable hot content cache 118 to enable retrieval of the value from storage array 126. Therefore, in one embodiment, the searchable hot content cache can reduce the number of accesses to memory for frequently accessed data values. A searchable hot content cache can therefore improve system performance by servicing memory requests from the cache and reducing the number of accesses to system memory, in accordance with embodiments.

Turning to FIG. 1B, as mentioned above, system 100B is similar to system 100A of FIG. 1A but with a searchable memory. For example, memory 130 of FIG. 1B can be a searchable memory. A searchable memory is a memory organization or structure which, given a data value, can efficiently determine whether the value is already stored or not, in accordance with embodiments. In one embodiment, a searchable memory is a regular memory that is organized by searchable memory logic 127 to facilitate efficient searches. In one embodiment, memory 130 is a deduplicated memory. A deduplicated memory is a memory to which deduplication logic (e.g., deduplication hardware, software, or a combination) applies techniques to avoid or minimize writing duplicates of data values to the memory. Deduplication techniques include, for example, searching the memory for a given value to be written to a given location. If the value is already stored in the memory, deduplication logic can map the given location to the already stored value, avoiding storing a duplicate of the value in the memory. In one embodiment in which a system includes a deduplicated memory and a hot content cache, the system can check the hot content cache for a requested data value prior to searching for the value in the memory, which can thus reduce the number of accesses to memory if there is a hit in the hot content cache.

In one such embodiment, searchable memory logic 127 implements the search algorithm of the searchable memory. In one embodiment that includes a searchable memory, requests that the hot content cache cannot service (e.g., when a hot content cache miss occurs), interface circuitry 114 forwards the request to searchable memory 130. In one embodiment, the searchable memory can also map more than one memory address to a single instance of a value. Thus, in one embodiment, in response to determining the given value is stored at a location in the searchable memory, searchable memory logic 127 maps the memory address associated with a request for a given value to the location in the searchable memory. In response to determining the given value is also not stored in the searchable memory, searchable memory logic stores the value at an available memory location. Additionally, as discussed above with respect to FIG. 1A, System 100B can be implemented as an SOC (system on a chip), or be implemented with standalone components.

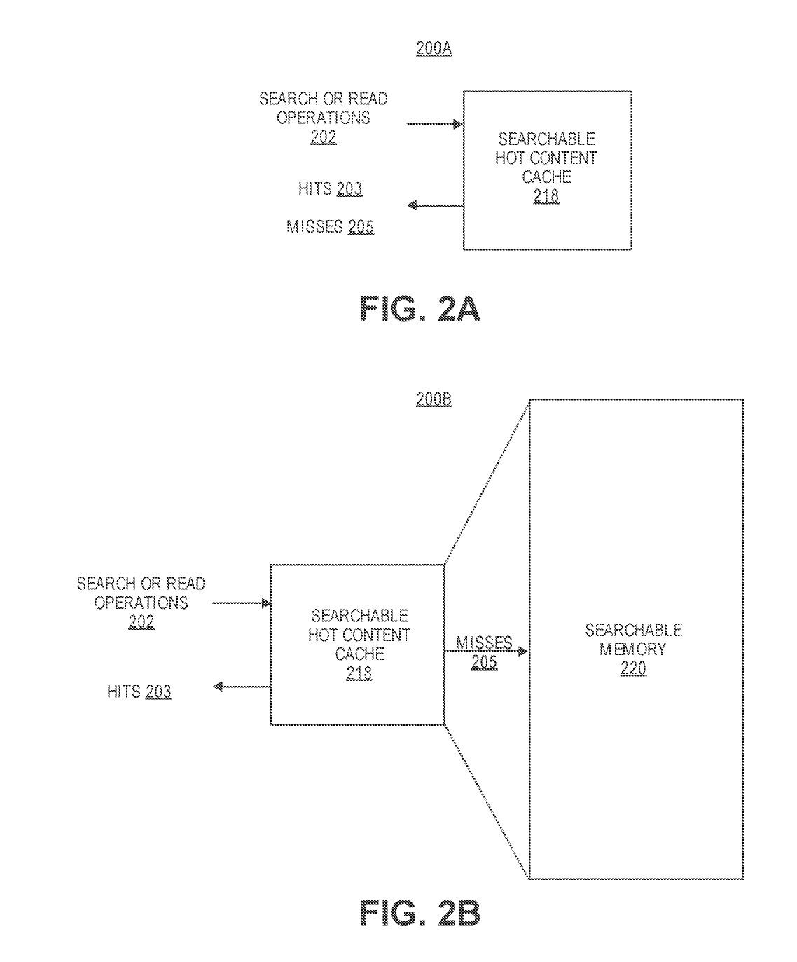

FIGS. 2A and 2B illustrate two exemplary architectures or modes that can employ searchable hot content cache, in accordance with embodiments. FIG. 2A is a block diagram of an architecture 200A or mode including a searchable hot content cache that works independently in the memory hierarchy, in accordance with an embodiment. In one embodiment, searchable hot content cache 218 can operate independently in the sense that the searchable hot content cache 218 defines, assigns, and manages the identifiers for locating cached data lines in the storage array of hot content cache 218. In one such embodiment, searchable hot content cache 218 is the final level of hot content management. Thus, when searchable hot content cache 218 performs search or read operations 202 (e.g., when hardware logic such as hardware logic 124 of FIG. 1A performs a search or read operation on a storage array), searchable hot content cache 218 can determine whether or not the value is stored without communicating with other hot content-aware devices such as a searchable memory. For example, as illustrated in FIG. 2A, in response to search or read operations 202, searchable hot content cache 218 returns hits 203 and misses 205 as a self-contained subsystem.

In contrast, FIG. 2B is a block diagram of an architecture 200B or mode including a searchable hot content cache and a searchable memory, in accordance with an embodiment. The architecture or mode illustrated in FIG. 2B is hierarchical in the sense that searchable hot content cache 218 caches values of a larger searchable memory 220, in accordance with an embodiment. The searchable memory 220 can be, for example, a deduplicated memory. In one embodiment, searchable memory 220 is responsible for definition and assignment of identifiers for cached data lines instead of searchable hot content cache 218. In one embodiment, searchable hot content cache 218 attempts to handle the search or read operations 202, but if there is a miss in searchable hot content cache 218, the interface circuitry can forward the operations to searchable memory 220. For example, in response to a determination that a given value is not stored in the storage array, interface circuitry (e.g., interface circuitry 114 of FIG. 1A) is to send the request to access the given value to searchable memory logic (e.g., searchable memory logic 127 of FIG. 1B) to search for the given value in a searchable memory. If searchable memory 220 also experiences a miss, searchable memory 220 can create a new entry for the value in searchable memory 220.

The independent and hierarchical approaches can be implemented as different modes. For example, searchable hot content cache 218 can include one or more mode registers to determine whether or not searchable hot content cache 218 is to operate independently or in conjunction with searchable memory 220. In another embodiment, independent and hierarchical modes are fixed attributes rather than modes that are controlled by a mode register. In yet another embodiment, some aspects of the mode of searchable hot content cache 218 are programmable with a mode register, while others are fixed.

FIG. 3 and FIG. 4 are block diagrams of a searchable hot content cache subsystem during performance of a search operation and read operation, respectively, in accordance with embodiments. According to an embodiment, searchable hot content cache subsystem performs a search operation for write requests and performs a read operation for read requests. FIGS. 3 and 4 illustrate one embodiment of the search and read operations in in which the searchable hot content cache is a set associative cache. A set-associative searchable hot content cache is structured as a number of sets, in accordance with an embodiment. Each set has one or more ways to cache data lines. A given data line in memory is mapped to one set in the cache. Set-associativity can have the benefit of reducing misses. However, in other embodiments, searchable hot content cache can be a direct mapped cache, a set-associative cache, a fully associative cache, or any other variation of cache. In a direct mapped cache, each data line is mapped to one location in the cache. In a fully associative cache, any data line in memory can be mapped to any location in the cache.

Turning to FIG. 3, to perform the search operation, subsystem 300 takes data 301 as an input, searches the hot content cache for the data, and if found, returns an identifier (data line id (DLID) 313) to the data in the cache. The searchable hot content cache subsystem 300 includes a storage array 307 to store hot content and hardware logic to search the storage array. In the example illustrated in FIG. 3, the hardware logic for performing a search operation includes hash logic 302, signature compare logic 311, data compare logic 318, and response logic 312. Other embodiments can include additional or different hardware logic for performing the search operations described herein. The following description sometimes refers collectively to the hardware logic used to perform operations as “hardware logic.”

Storage array 307 can be the same or similar to the storage array 126 described above with respect to FIG. 1A. In the example illustrated in FIG. 3, the storage array stores data 308 and other information relevant to operation of the cache such as state information and tags 304, signatures 306, reference counts (RCs) 310, and/or other information for operation of the searchable hot content cache. The hot content cache can support any granularity of data values, in accordance with embodiments. For example, in one embodiment, a given entry of storage array 307 includes data field 308 for storing a cacheline of data (e.g., 64 bytes). Other embodiments can include storage arrays that store other sizes of data. State information can include a status or valid field to indicate that an entry includes a valid data line. Thus, in one such embodiment, hardware logic initializes the valid bits of the entries of storage array 307 to indicate that none of the entries include a valid data line. As the storage array is filled with hot content, the hardware logic sets the valid bit to indicate the existence of a valid data line in the entry.

In one embodiment, tags include bits for identifying which data line is cached. According to embodiments, whether or not the searchable hot content cache uses tags depends on whether the cache is in independent mode or hierarchical mode. FIG. 2A and the corresponding description discusses independent mode and FIG. 2B and the corresponding description discusses hierarchical mode. In one such embodiment, a searchable hot content cache operating in hierarchical mode employs tags, and a searchable hot content cache operating in independent mode does not employ tags. In one such embodiment, a searchable hot content cache operating in independent mode does not employ tags because the location identifier (e.g., DLID) uniquely identifies the data line in the storage array of the hot content cache. In one embodiment, a searchable hot content cache operating in hierarchical mode does employ tags because the location identifier (e.g., DLID) refers to a location in the searchable memory. Thus, in one embodiment, the cache stores the location in memory of the cached data line using tags. Storage array can also include additional or different fields for operation of the searchable hot content cache. For example, in one embodiment, the entries of storage array 307 further include eviction policy bits to assist hardware logic in determining which data lines to evict. Storage array 307 can include a single storage array or multiple storage arrays to store data 308, state information and tags 304, signatures 306, reference counts 310, and/or other information for operation for the hot content cache.

As mentioned briefly above, in one embodiment, subsystem 300 takes data 301 as an input. Data 301 is the data to be written by a memory write request. In one such embodiment, interface circuitry (e.g., interface circuitry 114 of FIG. 1A) receives a memory write request and provides the data 301 to be written by the request (e.g., via a controller such as controller 115 of FIG. 1A). In response to receipt of the memory write request, the hardware logic is to search for the value of data 301 in storage array 307.

In one embodiment, searching for data 301 in the cache involves comparing a signature of the searched for data with signatures in the storage array. In one embodiment, a signature of given data is information (such as a string of bits) to enable identification of the data in an entry of the storage array of the hot content cache. In one embodiment, the signature has fewer bits than the data, and more than one data value can map to the same signature. In one embodiment, comparing signatures first (as opposed to, for example, comparing the entire data first) can reduce the number of compare operations performed for a given search. In one such embodiment, in order to compare signatures, hardware logic determines or generates a signature 305 for data 301. In the embodiment illustrated in FIG. 3, hash logic 302 generates a hash from data 301, and generates signature 305 to include one or more bits from the generated hash. In one embodiment, signature 305 includes a subset of the hash. In one embodiment, hash logic 302 performs a hash function to map data of one size (or arbitrary size) to data of another size. In one such embodiment, the hash function maps the relatively large data to a smaller sized hash. In one embodiment, the hash function is deterministic so that given the same data value, the hash function will always produce the same output. The hash function can perform some combination of logical operations on the input, such as a bitwise AND, bitwise OR, bitwise XOR, complement, modulo, shifts, or other logical operations to output a hash. After hash logic generates signature 305 for data 301, hardware logic can then compare the signature 305 with signatures stored in the storage array.

In the illustrated embodiment in which the hot content cache is set associative, hardware logic can determine whether data 301 is in the cache by comparing signature 305 to signatures in the set to which the data 301 is mapped to. Thus, in the illustrated embodiment, the hash generated by hash logic 302 includes one or more bits that hardware logic can use as a cache set index 303. In one such embodiment, cache set index 303 enables indexing into a particular set in the hot content cache. For example, FIG. 3 shows set index 303 indexing into set 303. In the illustrated example, set 303 can store up to four unique data lines. However, a cache set can include fewer than or more than four data lines. In one embodiment, the hash is deterministic and thus if data 301 is in the cache, the data will be located in set 303 identified by set index 303. Therefore, in one embodiment, hardware logic does not need to search entries of the storage array that are not in set 303.

In one embodiment, signature compare logic 311 compares signature 305 of the searched for data value 301 to signatures 306 in set 303. Signature compare logic 311 can include, for example, one or more comparator circuits to compare bits of signature 305 to one or more of signatures 306 and output zero or more matches. Signature compare logic 311 can compare signatures either in parallel or serially. In one embodiment in which the hot content cache is set associative, the maximum number of matches is the number of data lines in a set. In the example illustrated in FIG. 3 where there are four signatures in set 303, signature compare logic 311 can identify 0, 1, 2, 3, or 4 matches by comparing signatures in set 303 with signature 305. In one embodiment, if signature compare logic 311 determines that there are no matches, it means data 301 is not stored in the hot content cache.

In one embodiment, if signature compare logic 311 determines that there are one or more matches, data compare logic 318 compares data 301 with the data corresponding to the matching signature(s). For example, data compare logic 318 reads the data line from data 308 corresponding to each of the matching signatures. In one embodiment, data compare logic 318 includes one or more comparator circuits to compare bits of data 308 with the read data lines either in parallel or serially. If data compare logic 318 determines one of the data lines read from data 308 matches data 301, data compare logic indicates that there is a hot content cache hit. If, after comparing the data lines from 308 with matching signatures, data compare logic determines that there are no matches, data compare logic indicates that there is a hot content cache miss. In one embodiment, data compare logic outputs a hit/miss result 317, which can be sent to controller 314 for subsequent operations based on the result.

In one embodiment, if data compare logic 318 indicates that there is a hot content cache miss, hardware logic (e.g., such as hardware logic 124 or controller 115 of FIG. 1A) causes the associated memory request to be sent to memory for servicing.

In one embodiment, if data compare logic 318 indicates that there is a cache hit, data compare logic 318 sends the way 315 with the hit to response logic 312, in accordance with an embodiment. Response logic 312 can then compute and output an identifier (DLID 313) for the entry in storage array 307 in which the value is stored. DLID 313 includes information to enable hardware logic to identify an entry in storage array 307, in accordance with embodiments. According to embodiments, DLID 313 includes the cache set, cache way, and/or tags for the entry identified by DLID 313. The information included in DLID 313 can depend on whether the hot content cache is in an independent mode (e.g., as described above with respect to FIG. 2A), or a hierarchical mode (e.g., as described above with respect to FIG. 2B). In one embodiment, for a set associative cache in independent mode, DLID 313 includes the cache way and set. In another embodiment, for a set associative cache in hierarchical mode, DLID 313 includes the tag. In one embodiment, the tag includes hash bits output from hash logic 302. In one such embodiment, the signature can be folded into the tag to avoid replication. For example, in one embodiment, hardware logic can then map the associated memory address to the entry of the storage array with the hit using DLID. In one such embodiment, mapping the associated memory address to the entry of the storage array involves storing, in a translation table, an identifier (e.g., DLID 313) for the entry in storage array 307 in which the value is stored.

In one embodiment, the entries of the storage array include reference counts 310. In one such embodiment, the reference count for an entry indicates the number of memory addresses mapped to the entry. Thus, in response to a hit and subsequent mapping of the memory address to an entry in the cache, hardware logic is to increment the reference count, in accordance with an embodiment. In the example illustrated in FIG. 3, if data compare logic 318 indicates that there is a cache hit, hardware logic can increment the reference count for the entry to indicate that another memory address is mapped to the entry. In one embodiment, in response to detection of a subsequent request to write a different value to the memory address, the hardware logic is to delete a reference to the value by, for example, decrementing the reference count for the value.

According to embodiments, the process of deleting a reference to a value depends on whether the hot content cache is in independent mode (e.g., as described above with respect to FIG. 2A), or a hierarchical mode (e.g., as described above with respect to FIG. 2B). In one embodiment in which the hot content cache is in independent mode, a given DLID indexes into an entry in the storage array of the hot content cache. Therefore, hardware logic can update the reference count of the entry given the DLID. In one embodiment in which the hot content cache is in hierarchical mode, hardware logic uses set 303 to index into storage array 307 and read the tags located in set 303. Hardware logic then compares the tags from storage array 307 with a tag extracted from the DLID. If hardware logic determines that there is a match, the hardware logic updates (e.g., decrements) the corresponding reference count. If hardware logic determines that there is no match (a hot content cache miss), interface logic sends the delete reference operation to the searchable memory. In one embodiment, the searchable hot content cache keeps data in the hot content cache until all references are deleted. When no more references to the data line exist (e.g., when the reference count is 0), hardware logic can deallocate the data from the hot content cache.

FIG. 4 is a block diagram of a searchable hot content cache subsystem 400 during performance of a read operation, in accordance with an embodiment. In one embodiment, when a memory read request is received (e.g., by interface circuitry such as interface circuitry 114 of FIG. 1A), hardware logic checks a translation table to see if the memory address was previously mapped to the hot content cache. If the memory address is in the translation table, the translation table provides an identifier (e.g., DLID) to enable reading the requested value from the hot content cache.

In one embodiment, to perform a read operation, subsystem 400 takes an identifier (DLID 313) for an entry in storage array 307, and if there is a cache hit, returns data 409. However, the read operation can involve a different process depending on whether the searchable hot content cache is in an independent or hierarchical mode. FIG. 2A and the corresponding description discusses independent mode and FIG. 2B and the corresponding description discusses hierarchical mode, in accordance with embodiments. In one embodiment, in independent mode, DLID 313 points directly to the cache set and way to read. In one such embodiment, in independent mode, a valid DLID indicates that the requested data is stored in the hot content cache. Thus, in independent mode, hardware logic can directly read data from the entry of the storage array based on DLID 313.

FIG. 4 illustrates an embodiment in which the hot content cache is in hierarchical mode. In hierarchical mode, extract logic 402 receives DLID 313 as input and outputs set 303 for indexing into storage array 307 and tag 405 from DLID 313. In one such embodiment, extract logic 402 includes circuitry for extracting set 303 and/or tag 405. Hardware logic uses extracted set 303 to index into storage array 307. Tag compare logic 406 reads tags 304 from the entries in set 303 and compares the read tags to tag 405. Tag compare logic 406 can include one or more comparators to compare the bits of tag 405 to tags from storage array 307. Tag compare logic 406 can then determine whether there is a hit or miss and output the hit/miss result 407. If tag compare logic 406 determines that one of tags 304 matches tag 405, tag compare logic 406 indicates that a cache hit occurred and outputs data 409 from storage array 307. For example, referring to FIG. 1A, tag compare logic 406 communicates to other hardware logic such as hardware logic 124 or controller 115 that the cache hit occurred. The controller can then cause data 409 to be sent to the requesting processor. If tag compare logic 406 determines that the tags do not match, tag compare logic 406 indicates a cache miss occurred. For example, referring again to FIG. 1A, tag compare logic 406 communicates to other hardware logic such as hardware logic 124 or controller 115 that the cache miss occurred. In one such embodiment, in hierarchical mode, the controller can then cause the request to be sent to a searchable memory.

Thus, searchable hot content cache can reduce the number of memory accesses for frequently accessed data values, and can therefore improve system performance, in accordance with embodiments.

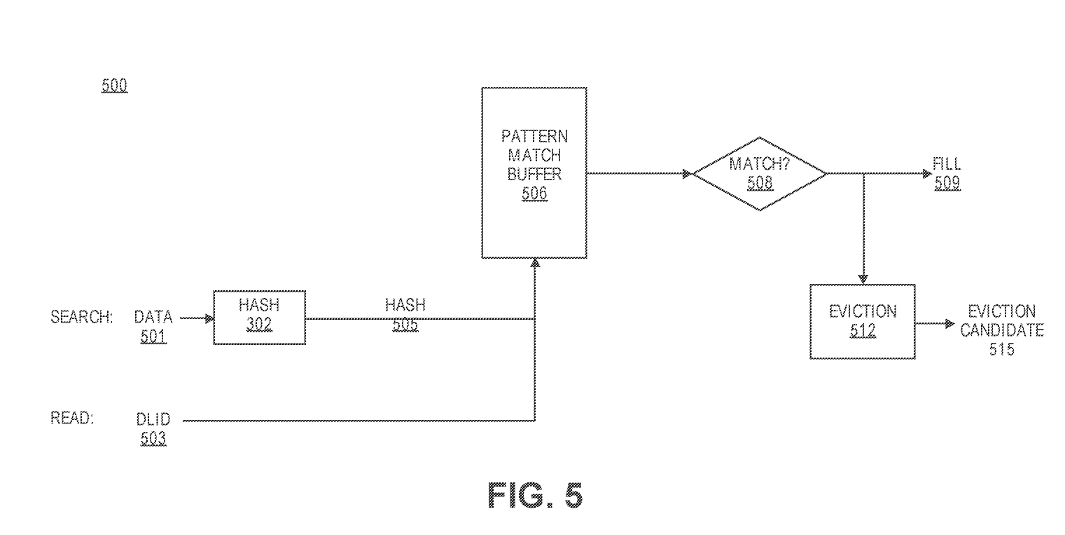

FIG. 5 is a block diagram of a searchable hot content cache subsystem during performance of a search or read operation, including a determination of whether to perform a fill operation, in accordance with an embodiment. As discussed above, according to embodiments, a searchable hot content cache performs a fill operation when the cache subsystem detects hot content. A fill operation can apply a fill policy to determine which data lines to fill into the cache. In one embodiment, fill circuitry 500 implements a fill policy and outputs a signal 509 to indicate whether a given data line is a good candidate for insertion into the hot content cache.

In one embodiment, fill circuitry 500 includes pattern match buffer 506. Pattern match buffer 506 can be a first in first out (FIFO) buffer (e.g., a content addressable memory (CAM) FIFO) or other suitable circuitry for storing memory request information. In one such embodiment, pattern match buffer 506 tracks requests within a window of requests or a window of time. In one embodiment in which pattern match buffer 506 tracks requests within a window of requests, the window of requests includes hundreds to thousands of requests. Other embodiments can include windows of requests that are less than one hundred or greater than thousands (e.g., greater than or equal to ten thousand) that are suitable for identifying hot content. In one embodiment in which pattern match buffer 506 tracks requests within a window of time, the window of time is a suitable amount of time to enable detection of hot data, and is dependent upon the speed of the system.

In the example illustrated in FIG. 5, fill circuitry 500 includes match logic 508. In one embodiment, match logic 508 detects if there is a match of values stored in the pattern match buffer, which indicates that there were multiple requests to access a given value within the defined window. In one embodiment, if match logic 508 detects a match, match logic 508 outputs a fill signal 509. Match logic 508 can determine that a value should be stored to the storage array based on detecting the value twice in the window, or another number of times within the window. For example, match logic 508 can determine whether to fill based on whether or not the number of observed requests for a value meets or exceeds a threshold. The threshold can be static or programmable and based on, for example, a mode register or other setting. Hardware logic, such as logic 124 of FIG. 1A, detects fill signal 509 and stores the hot data value in the storage array.

According to embodiments, pattern match buffer 506 can store different information for read requests and write requests. For example, in one embodiment, pattern match buffer stores signatures of values to be written by write requests within the window. For example, as discussed above, the signature of the value to be written can include one or more bits of a hash. In the embodiment in FIG. 5, hash logic 302 receives data 501 and determines or generates hash 505. Pattern match buffer can then store one or more bits of hash 505 to identify the requested value. Match logic 508 can then compare the signatures in the buffer to determine whether the number meets or exceeds the threshold.

In one embodiment, pattern match buffer stores identifiers (e.g., DLIDs) for read requests within the window. In the embodiment in FIG. 5, pattern match buffer 506 receives and stores DLID 503. As discussed above, DLIDs include information to enable indexing into the storage array of the searchable hot content cache. For example, DLIDs can include set, way, and/or tag information. In one embodiment in which the hot content cache is operating in hierarchical mode, read requests have DLID because the data values are in the searchable memory. In one such embodiment, the translation table provides a DLID, which the pattern match buffer stores. Match logic 508 can then compare the DLIDs in the buffer to determine whether the number meets or exceeds the threshold. In another embodiment, pattern match buffer 506 stores signatures of values for both read and write requests. In one such embodiment, pattern match buffer stores the signature for read requests after the data reply comes back from memory.

In one embodiment, pattern match buffer only stores signatures and/or identifiers for values that are not already in the cache, thus reserving entries in the pattern match buffer for misses. Although FIG. 5 illustrates a single pattern match buffer, fill circuitry 500 could include more than one pattern match buffer (e.g., separate pattern match buffers for read and write requests). Alternatively, fill circuitry 500 can include no special pattern match buffers, but instead implement the pattern match buffer as a part of the hot content cache.

For example, in one embodiment, the searchable hot content cache can implement a pattern match buffer as a part of the storage array of the hot content cache (e.g., storage array 126 of FIG. 1A) instead of as a separate buffer. For example, the storage array of the cache can include certain predefined ways in the tags that have no corresponding data field. For example, in one such embodiment, the first time a value is accessed, the hardware logic stores the tags in the storage array, but not the data. If the hardware logic detects a second (or other number of accesses that meets or exceeds the threshold) to the value, the hardware logic determines the data is hot and stores the data in the entry of the storage array. In one such embodiment, a hit in these predefined ways causes hardware logic to fill the data into an entry of the hot content cache (e.g., into a way of the cache that includes a data field). In another such embodiment, a separate set-associative structure operates as the pattern match buffer to store DLIDs and/or signatures. For example, in one embodiment, a set-associative structure can include sets of small CAMs. In one such embodiment, hardware logic deterministically maps each DLID and/or signature to one set, and only performs a pattern match search within its own set.

In one embodiment, hardware logic determines whether or not a value is hot by tracking the reference count of the value (e.g., using the reference count field in the storage array such as reference counts 310 in FIG. 3). In one such embodiment, hardware increments the reference count in response to detecting requests to access the value. In one such embodiment, if hardware logic determines the reference count meets or exceeds a threshold value, the hardware logic fills the data into the storage array. In one embodiment, hardware logic can use the state bits 304 to indicate whether or not the data has been filled into a given entry.

As briefly discussed above with respect to FIG. 1A, the searchable hot content cache also includes logic to evict values to make room for new hot content. For example, in the embodiment illustrated in FIG. 5, eviction circuitry 512 determines which entries of the hot content cache to evict and outputs one or more eviction candidates 515. In the event that the storage array (e.g., storage array 126 of FIG. 1A) is full, prior to storing a new value in the storage array, hardware logic evicts an existing value from the storage array based on eviction candidate 515. Eviction circuitry 512 can implement any cache eviction policy, such as a least recently used (LRU) policy, a pseudo-LRU policy, a reference count (RC)-based eviction policy, a usage category-based policy, or any other suitable policy for determining candidates for eviction from the searchable hot content cache.

In one embodiment in which eviction circuitry 512 implements an LRU policy, the entries of the storage array of the hot content cache include LRU state bits. For example, referring to FIG. 3, state bits 304 can include LRU bits. In one such embodiment, hardware logic keeps track of which data is least recently used by updating the LRU bits when the entry is accessed. In one such embodiment, eviction circuitry 512 selects the entry that is least recently used by comparing the LRU state bits. A pseudo-LRU policy can include any approximation to an LRU scheme. In one embodiment implementing an RC-based eviction policy, eviction circuitry 512 selects the entry in the storage array of the cache with the lowest reference count as the eviction candidate. In one embodiment implementing a usage category-based policy, eviction circuitry 512 classifies entries into one of multiple categories based on usage. For example, the entries of the cache can be categorized into a lowest use category, a medium use category, and a highest use category. Other granularities are also possible. In one such embodiment, eviction circuitry 512 selects an entry for eviction based on the lower use category.

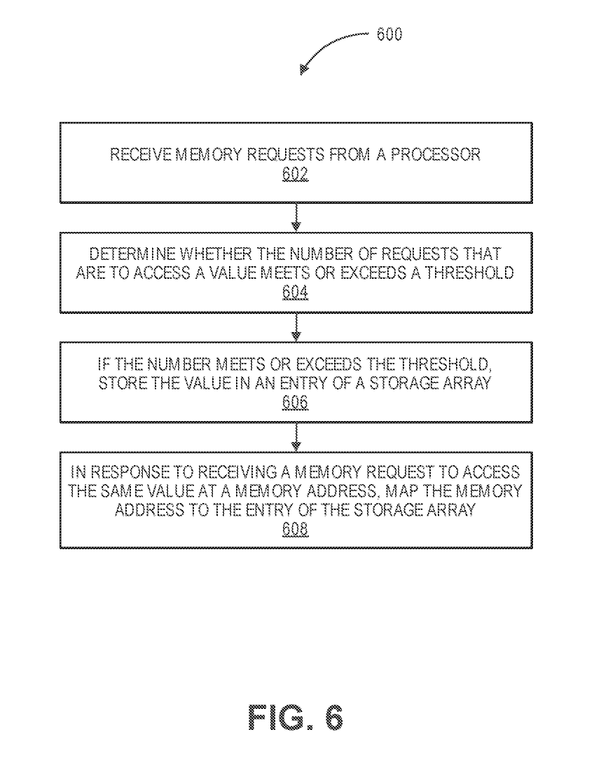

FIGS. 6, 7, and 8 are flow diagrams illustrating processes performed in a searchable hot content based cache circuit, in accordance with embodiments. The processes described with respect to FIGS. 6, 7, and 8 can be performed by hardware logic and circuitry, such as interface circuitry 114, controller 115, access logic 120, searchable hot content cache logic 124 of FIG. 1A, and/or other circuitry suitable for performing the processes. Some of the following descriptions refer generally to “hardware logic” as performing the processes.

FIG. 6 is a flow diagram of a process performed by a searchable hot content cache, in accordance with an embodiment. In one embodiment, process 600 begins with interface circuitry receiving memory requests from a processor, at operation 602. For example, referring to FIG. 1A, interface circuitry 114 receives memory read or write requests from processor 110. Hardware logic determines whether a number of requests that are to access a value meets or exceeds a threshold, at operation 604. For example, referring to FIG. 1A again, hardware logic 124 tracks values and determines whether the number of requests for a given value meets or exceeds a threshold. If the number meets or exceeds the threshold, hardware logic stores the value in an entry of a storage array (e.g., storage array 126 of FIG. 1A), at operation 606.

Interface circuitry further receives a memory request to access the same value at a memory address. In response to receiving the memory request for the same value at the memory address, hardware logic maps the memory address to the same entry of the storage array, at operation 608. In the case of a read request, mapping the memory address to the same entry can involve, for example, redirecting the request to retrieve data from the entry of the storage array of the hot content cache, in accordance with an embodiment. Redirecting the request to the entry of the storage array of the hot content cache can involve reading the identifier associated with the memory address in a translation table (e.g., translation table 116 of FIG. 1A). In the case of a write request, mapping the memory address to the same entry can involve, for example, storing the memory address and an identifier for the entry in a translation table. The translation table can then redirect subsequent requests to the memory address to the hot content cache.

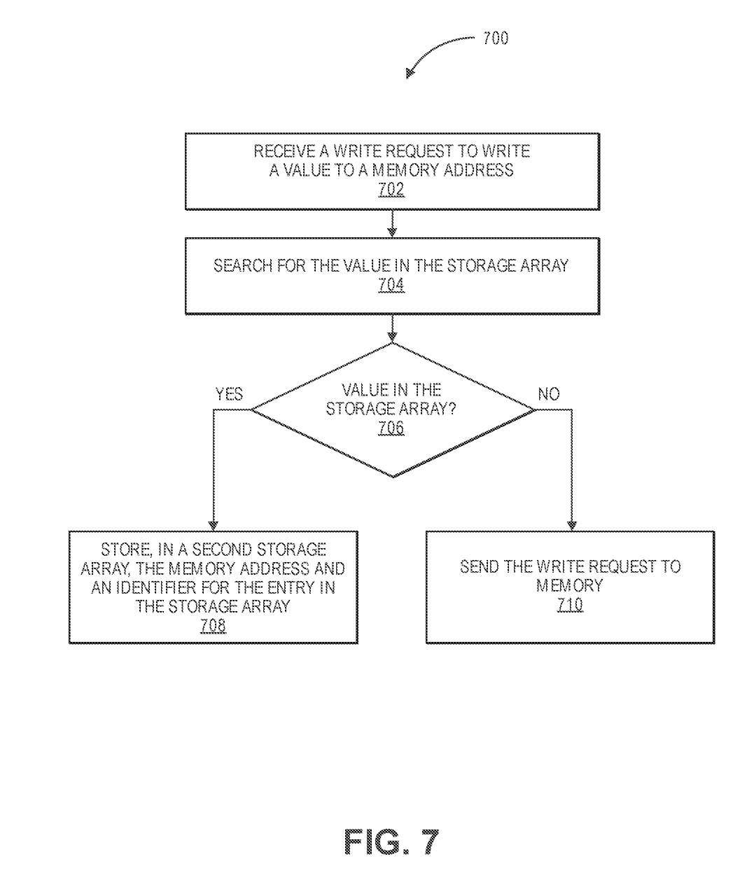

FIG. 7 is a flow diagram of a process of performing a search operation in a searchable hot content cache, in accordance with an embodiment. Process 700 begins when interface circuitry receives a request to write a value to a memory address, at operation 702. Hardware logic then performs a search for the value in the storage array, at operation 704. FIG. 3 and the corresponding description describes a search operation in accordance with one embodiment. In one embodiment, performing a search involves determining a signature of the searched for value, comparing the signature of the searched for value with signatures stored in the storage array, and in response to finding a matching signature in the storage array, comparing the searched for value with a value in the storage array corresponding to the matching signature. If the value is in the storage array, 706 YES branch, hardware logic stores, in a second storage array, the memory address and an identifier for the entry of the storage array, at operation 708. For example, referring to FIG. 1A, if the value is in storage array 126, hardware logic 124 stores the memory address and an identifier for the entry of storage array 122 of translation table 116. If the value is not in the storage array, 706 NO branch, hardware logic sends the write request to memory for servicing, at operation 710.

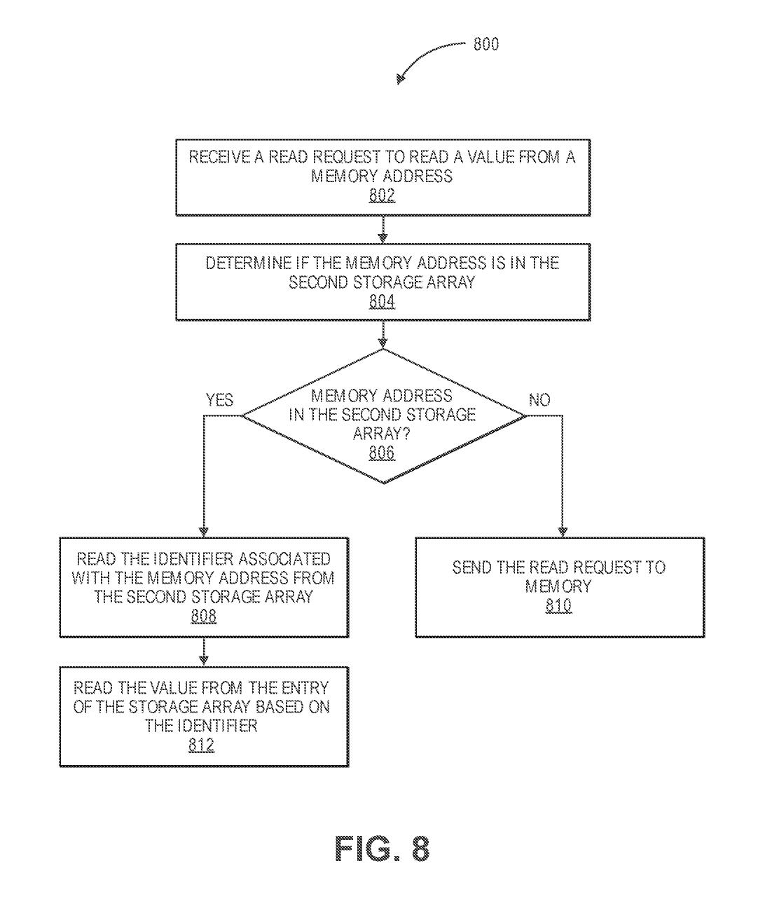

FIG. 8 is a flow diagram of a process of performing a read operation in a searchable hot content cache, in accordance with an embodiment. Process 800 begins with interface circuitry receiving a read request to read a value from a memory address, at operation 802. Hardware logic determines whether or not the memory address is in the second storage array, at operation 804. For example, referring to FIG. 1A, access logic 120 determines whether or not the memory address is in storage array 122. If the memory address is in the second storage array, 806 YES branch, hardware logic reads the identifier associated with the memory address from the second storage array, at operation 808. Hardware logic can then read the value from the entry of the storage array of the hot content cache based on the identifier, at operation 812. For example, referring again to FIG. 1A, hardware logic 124 can read the value from the entry of storage array 126. FIG. 4 and the corresponding description also illustrates an example of a read operation given an identifier (e.g., DLID 313) for an entry of the storage array of the hot content cache. If the memory address is not in the second storage array, 806 NO branch, hardware logic sends the read request to memory for servicing, at operation 810.

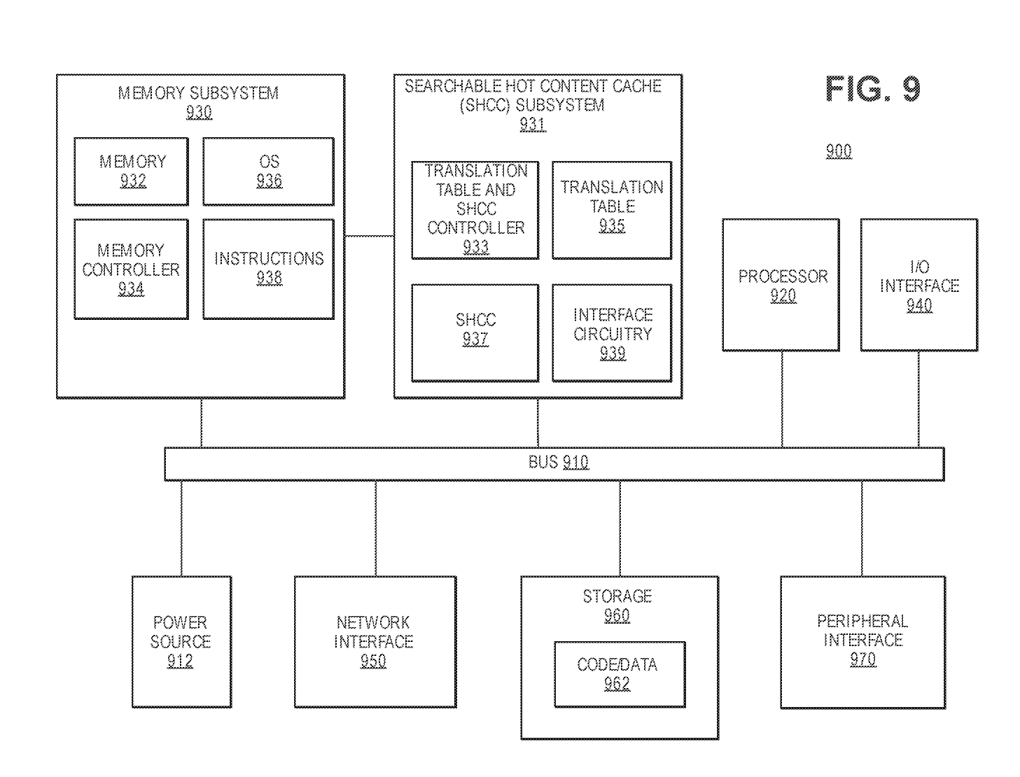

FIG. 9 is a block diagram of an embodiment of a computing system in which a searchable hot content cache can be implemented. System 900 represents a computing device in accordance with any embodiment described herein, and can be a laptop computer, a desktop computer, a server, a gaming or entertainment control system, a scanner, copier, printer, routing or switching device, or other electronic device. System 900 includes processor 920, which provides processing, operation management, and execution of instructions for system 900. Processor 920 can include any type of microprocessor, central processing unit (CPU), processing core, or other processing hardware to provide processing for system 900. Processor 920 controls the overall operation of system 900, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. Processor 920 can execute data stored in memory 932 and/or write or edit data stored in memory 932.

Memory subsystem 930 represents the main memory of system 900, and provides temporary storage for code to be executed by processor 920, or data values to be used in executing a routine. Memory subsystem 930 can include one or more memory devices such as read-only memory (ROM), flash memory, one or more varieties of random access memory (RAM), or other memory devices, or a combination of such devices. Memory subsystem 930 stores and hosts, among other things, operating system (OS) 936 to provide a software platform for execution of instructions in system 900. Additionally, other instructions 938 are stored and executed from memory subsystem 930 to provide the logic and the processing of system 900. OS 936 and instructions 938 are executed by processor 920. Memory subsystem 930 includes memory device 932 where it stores data, instructions, programs, or other items. In one embodiment, memory device 932 includes a searchable memory. In one embodiment, memory subsystem includes memory controller 934, which is a memory controller to generate and issue commands to memory device 932. It will be understood that memory controller 934 could be a physical part of processor 920.

Processor 920 and memory subsystem 930 are coupled to bus/bus system 910. Bus 910 is an abstraction that represents any one or more separate physical buses, communication lines/interfaces, and/or point-to-point connections, connected by appropriate bridges, adapters, and/or controllers. Therefore, bus 910 can include, for example, one or more of a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (commonly referred to as “Firewire”). The buses of bus 910 can also correspond to interfaces in network interface 950.

Power source 912 couples to bus 910 to provide power to the components of system 900. In one embodiment, power source 912 includes an AC to DC (alternating current to direct current) adapter to plug into a wall outlet. Such AC power can be renewable energy (e.g., solar power). In one embodiment, power source 912 includes only DC power, which can be provided by a DC power source, such as an external AC to DC converter. In one embodiment, power source 912 includes wireless charging hardware to charge via proximity to a charging field. In one embodiment, power source 912 can include an internal battery, AC-DC converter at least to receive alternating current and supply direct current, renewable energy source (e.g., solar power or motion based power), or the like.

System 900 also includes one or more input/output (I/O) interface(s) 940, network interface 950, one or more internal mass storage device(s) 960, and peripheral interface 970 coupled to bus 910. I/O interface 940 can include one or more interface components through which a user interacts with system 900 (e.g., video, audio, and/or alphanumeric interfacing). In one embodiment, I/O interface 940 generates a display based on data stored in memory and/or operations executed by processor 920. Network interface 950 provides system 900 the ability to communicate with remote devices (e.g., servers, other computing devices) over one or more networks. Network interface 950 can include an Ethernet adapter, wireless interconnection components, USB (universal serial bus), or other wired or wireless standards-based or proprietary interfaces. Network interface 950 can exchange data with a remote device, which can include sending data stored in memory and/or receive data to be stored in memory.

Storage 960 can be or include any conventional medium for storing large amounts of data in a nonvolatile manner, such as one or more magnetic, solid state, or optical based disks, or a combination. Storage 960 holds code or instructions and data 962 in a persistent state (i.e., the value is retained despite interruption of power to system 900). Storage 960 can be generically considered to be a “memory,” although memory 930 is the executing or operating memory to provide instructions to processor 920. Whereas storage 960 is nonvolatile, memory 930 can include volatile memory (i.e., the value or state of the data is indeterminate if power is interrupted to system 900).

Peripheral interface 970 can include any hardware interface not specifically mentioned above. Peripherals refer generally to devices that connect dependently to system 900. A dependent connection is one where system 900 provides the software and/or hardware platform on which operation executes, and with which a user interacts.

In one embodiment, system 900 includes a searchable hot content cache in accordance with embodiments described herein. In the embodiment illustrated in FIG. 9, a searchable hot content cache subsystem 931 includes interface circuitry 939 to receive memory requests. Interface circuitry 939 can be the same or similar to interface circuitry 114 described above with respect to FIG. 1A. Subsystem 931 further includes a searchable hot content cache 937 to store hot data values. Searchable hot content cache 937 can be the same or similar to searchable hot content cache 118 of FIG. 1A. Subsystem 931 further includes translation table 935 to map memory addresses to entries in the searchable hot content cache 937, in accordance with embodiments described herein. Translation table 935 can be the same or similar to translation table 116 described above with respect to FIG. 1A. The embodiment illustrated in FIG. 9 further includes controller 933, which includes circuitry to control the operation of translation table 935 and searchable hot content cache 937.

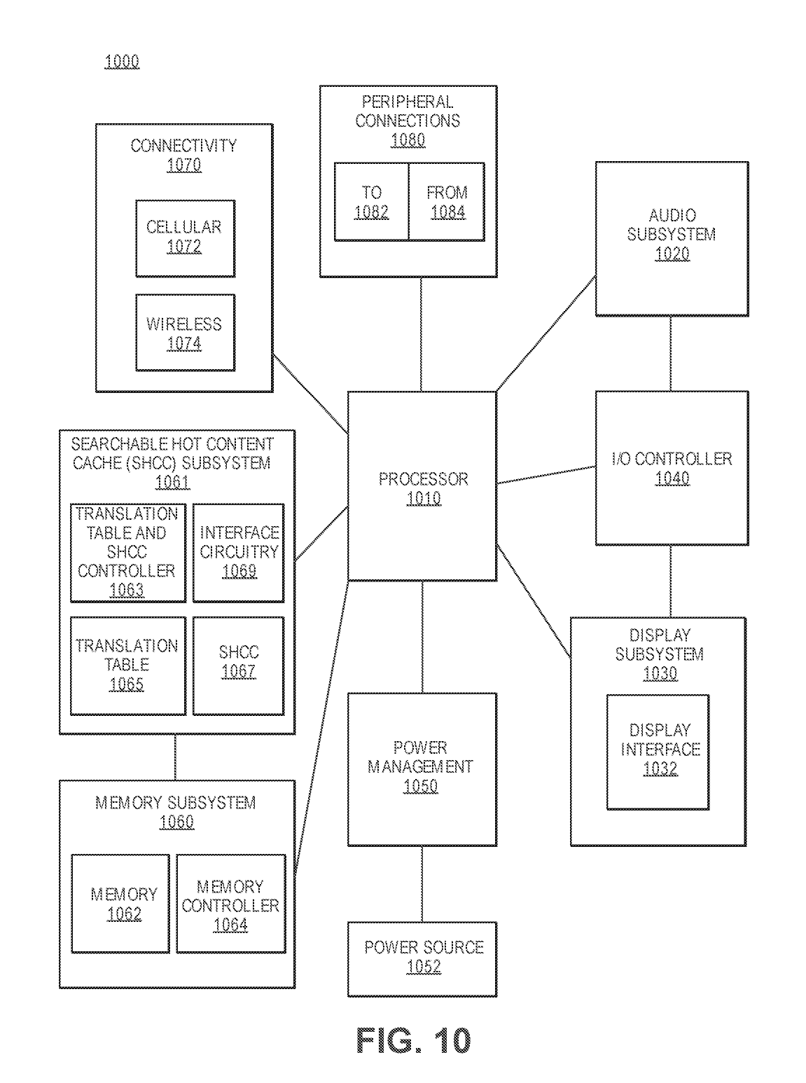

FIG. 10 is a block diagram of an embodiment of a mobile device in which a searchable hot content cache can be implemented. Device 1000 represents a mobile computing device, such as a computing tablet, a mobile phone or smartphone, a wireless-enabled e-reader, wearable computing device, or other mobile device. It will be understood that certain of the components are shown generally, and not all components of such a device are shown in device 1000.

Device 1000 includes processor 1010, which performs the primary processing operations of device 1000. Processor 1010 can include one or more physical devices, such as microprocessors, application processors, microcontrollers, programmable logic devices, or other processing means. The processing operations performed by processor 1010 include the execution of an operating platform or operating system on which applications and/or device functions are executed. The processing operations include operations related to I/O (input/output) with a human user or with other devices, operations related to power management, and/or operations related to connecting device 1000 to another device. The processing operations can also include operations related to audio I/O and/or display I/O. Processor 1010 can execute data stored in memory and/or write or edit data stored in memory.

In one embodiment, device 1000 includes audio subsystem 1020, which represents hardware (e.g., audio hardware and audio circuits) and software (e.g., drivers, codecs) components associated with providing audio functions to the computing device. Audio functions can include speaker and/or headphone output, as well as microphone input. Devices for such functions can be integrated into device 1000, or connected to device 1000. In one embodiment, a user interacts with device 1000 by providing audio commands that are received and processed by processor 1010.

Display subsystem 1030 represents hardware (e.g., display devices) and software (e.g., drivers) components that provide a visual and/or tactile display for a user to interact with the computing device. Display subsystem 1030 includes display interface 1032, which includes the particular screen or hardware device used to provide a display to a user. In one embodiment, display interface 1032 includes logic separate from processor 1010 to perform at least some processing related to the display. In one embodiment, display subsystem 1030 includes a touchscreen device that provides both output and input to a user. In one embodiment, display subsystem 1030 includes a high definition (HD) display that provides an output to a user. High definition can refer to a display having a pixel density of approximately 100 PPI (pixels per inch) or greater, and can include formats such as full HD (e.g., 1080p), retina displays, 4K (ultra high definition or UHD), or others. In one embodiment, display subsystem 1030 generates display information based on data stored in memory and/or operations executed by processor 1010.

I/O controller 1040 represents hardware devices and software components related to interaction with a user. I/O controller 1040 can operate to manage hardware that is part of audio subsystem 1020 and/or display subsystem 1030. Additionally, I/O controller 1040 illustrates a connection point for additional devices that connect to device 1000 through which a user might interact with the system. For example, devices that can be attached to device 1000 might include microphone devices, speaker or stereo systems, video systems or other display device, keyboard or keypad devices, or other I/O devices for use with specific applications such as card readers or other devices.

As mentioned above, I/O controller 1040 can interact with audio subsystem 1020 and/or display subsystem 1030. For example, input through a microphone or other audio device can provide input or commands for one or more applications or functions of device 1000. Additionally, audio output can be provided instead of or in addition to display output. In another example, if display subsystem includes a touchscreen, the display device also acts as an input device, which can be at least partially managed by I/O controller 1040. There can also be additional buttons or switches on device 1000 to provide I/O functions managed by I/O controller 1040.

In one embodiment, I/O controller 1040 manages devices such as accelerometers, cameras, light sensors or other environmental sensors, gyroscopes, global positioning system (GPS), or other hardware that can be included in device 1000. The input can be part of direct user interaction, as well as providing environmental input to the system to influence its operations (such as filtering for noise, adjusting displays for brightness detection, applying a flash for a camera, or other features).

In one embodiment, device 1000 includes power management 1050 that manages battery power usage, charging of the battery, and features related to power saving operation. Power management 1050 manages power from power source 1052, which provides power to the components of system 1000. In one embodiment, power source 1052 includes an AC to DC (alternating current to direct current) adapter to plug into a wall outlet. Such AC power can be renewable energy (e.g., solar power). In one embodiment, power source 1052 includes only DC power, which can be provided by a DC power source, such as an external AC to DC converter. In one embodiment, power source 1052 includes wireless charging hardware to charge via proximity to a charging field. In one embodiment, power source 1052 can include an internal battery, AC-DC converter at least to receive alternating current and supply direct current, renewable energy source (e.g., solar power or motion based power), or the like.

Memory subsystem 1060 includes memory device(s) 1062 for storing information in device 1000. Memory subsystem 1060 can include nonvolatile (state does not change if power to the memory device is interrupted) and/or volatile (state is indeterminate if power to the memory device is interrupted) memory devices. In one embodiment, memory devices include a searchable memory. Memory 1060 can store application data, user data, music, photos, documents, or other data, as well as system data (whether long-term or temporary) related to the execution of the applications and functions of system 1000. In one embodiment, memory subsystem 1060 includes memory controller 1064 (which could also be considered part of the control of system 1000, and could potentially be considered part of processor 1010). Memory controller 1064 includes a scheduler to generate and issue commands to memory device 1062.

Connectivity 1070 includes hardware devices (e.g., wireless and/or wired connectors and communication hardware) and software components (e.g., drivers, protocol stacks) to enable device 1000 to communicate with external devices. The external device could be separate devices, such as other computing devices, wireless access points or base stations, as well as peripherals such as headsets, printers, or other devices. In one embodiment, system 1000 exchanges data with an external device for storage in memory and/or for display on a display device. The exchanged data can include data to be stored in memory and/or data already stored in memory, to read, write, or edit data.

Connectivity 1070 can include multiple different types of connectivity. To generalize, device 1000 is illustrated with cellular connectivity 1072 and wireless connectivity 1074. Cellular connectivity 1072 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, LTE (long term evolution—also referred to as “4G”), or other cellular service standards. Wireless connectivity 1074 refers to wireless connectivity that is not cellular, and can include personal area networks (such as Bluetooth), local area networks (such as WiFi), and/or wide area networks (such as WiMax), or other wireless communication. Wireless communication refers to transfer of data through the use of modulated electromagnetic radiation through a non-solid medium. Wired communication occurs through a solid communication medium.

Peripheral connections 1080 include hardware interfaces and connectors, as well as software components (e.g., drivers, protocol stacks) to make peripheral connections. It will be understood that device 1000 could both be a peripheral device (“to” 1082) to other computing devices, as well as have peripheral devices (“from” 1084) connected to it. Device 1000 commonly has a “docking” connector to connect to other computing devices for purposes such as managing (e.g., downloading and/or uploading, changing, synchronizing) content on device 1000. Additionally, a docking connector can allow device 1000 to connect to certain peripherals that allow device 1000 to control content output, for example, to audiovisual or other systems.

In addition to a proprietary docking connector or other proprietary connection hardware, device 1000 can make peripheral connections 1080 via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other type.

In one embodiment, device 1000 includes a searchable hot content cache in accordance with embodiments described herein. In the embodiment illustrated in FIG. 10, a searchable hot content cache subsystem 1061 includes interface circuitry 1069 to receive memory requests. Interface circuitry 1069 can be the same or similar to interface circuitry 114 described above with respect to FIG. 1A. Subsystem 1061 further includes a searchable hot content cache 1067 to store hot data values. Searchable hot content cache 1067 can be the same or similar to searchable hot content cache 118 of FIG. 1A. Subsystem 1061 further includes translation table 1065 to map memory addresses to entries in the searchable hot content cache 1067 in accordance with embodiments described herein. Translation table 1065 can be the same or similar to translation table 116 described above with respect to FIG. 1A. The embodiment illustrated in FIG. 10 further includes controller 1063, which includes circuitry to control the operation of translation table 1065 and searchable hot content cache 1067.

Thus, in one embodiment, a circuit can detect and store frequently accessed values in a searchable hot content cache. The circuit can search the hot content cache to see if values already exist in the hot content cache, which can enable memory accesses for frequently accessed values to be serviced by the hot content cache instead of memory. Thus, embodiments can reduce the cost (e.g., in terms of bandwidth, latency, and power) of accessing frequently accessed data values.

The following are exemplary embodiments. In one embodiment, a circuitry includes interface circuitry to receive memory requests from a processor. The circuit includes hardware logic to determine that a number of the memory requests that are to access a value meets or exceeds a threshold. The circuit includes a storage array to store the value in an entry based on a determination that the number meets or exceeds the threshold. In response to receipt of a memory request from the processor to access the value at a memory address, the hardware logic is to map the memory address to the entry of the storage array.

In one embodiment, the hardware logic is to further update a reference count for the entry to indicate a number of memory addresses mapped to the entry. In one embodiment, in response to the map of the memory address to the entry, the hardware logic is to increment the reference count. In one embodiment, in response to detection of a subsequent request to write a different value to the memory address, the hardware logic is to decrement the reference count.

In one embodiment, the circuit further includes a second storage array to store the memory address and an identifier for the entry of the storage array. In one embodiment, the memory request includes a read request, and the hardware logic to map the memory address to the entry is to read the value from the entry of the storage array. In response to receipt of the read request, the hardware logic is to determine that the memory address is in the second storage array. The hardware logic is to further read the identifier associated with the memory address in the second storage array, and the hardware logic is to read the value from the entry of the storage array based on the identifier. In one embodiment, the memory request includes a write request, and the hardware logic to map the memory address to the entry of the storage array is to, store, in the second storage array, the memory address and the identifier for the entry. In one embodiment, in response to receipt of the write request, the hardware logic is to search for the value in the storage array. The hardware logic is to map the memory address to the entry of the storage array based on a determination that the value is stored in the entry.

In one embodiment, the hardware logic to search for the value in the storage array is to determine a signature of the searched for value, compare the signature of the searched for value with signatures stored in the storage array, and in response to a matching signature, compare the searched for value with a value in the storage array corresponding to the matching signature.

In one embodiment, the hardware logic to determine that the number meets or exceeds the threshold is to track values within a window of requests and determine the value was requested more than once within the window of requests.

In one embodiment, the hardware logic to determine that the number meets or exceeds the threshold is to track values within a window of time and determine the value was requested more than once within the window of time.

In one embodiment, the circuit further includes a buffer to store signatures of values to be written by write requests within a window. The hardware logic is to compare the signatures in the buffer to determine whether the number meets or exceeds the threshold. In one such embodiment, the buffer is to store identifiers for entries of the storage array to which read requests within the window are redirected to. The hardware logic is to compare the identifiers in the buffer to determine whether the number meets or exceeds the threshold.

In one embodiment, the hardware logic to determine that the number meets or exceeds the threshold is to track the reference count of the value in an entry of the storage array and determine the reference count meets or exceeds a threshold value.

In one embodiment, in response to a determination that a given value is not stored in the storage array, the interface circuitry is to send a given memory request that is to access the given value to searchable memory logic to search for the given value in a searchable memory.

In one embodiment, a system includes a processor and a circuit communicatively coupled with the processor. The circuit includes interface circuitry to receive memory requests from the processor, hardware logic to determine that a number of the memory requests that is to access a value meets or exceeds a threshold, and a storage array to store the value in an entry based on a determination that the number meets or exceeds the threshold. In response to receipt of a memory request from the processor to access the value at a memory address, the hardware logic is to map the memory address to the entry of the storage array.

In one embodiment, the system also includes any of a display communicatively coupled to the processor, a network interface communicatively coupled to the processor, or a battery coupled to provide power to the system.

In one embodiment, a method includes receiving memory requests from a processor, determining that a number of the memory requests that are to access a value meets or exceeds a threshold, and storing the value in an entry of a storage array based on a determination that the number meets or exceeds the threshold. In response to receiving a memory request from the processor to access the value at a memory address, mapping the memory address to the entry of the storage array.

In one embodiment, the method also includes updating a reference count for the entry to indicate a number of memory addresses mapped to the entry. In one embodiment, storing the value in the storage array further includes updating a status field of the entry to indicate that the entry includes a valid data line. In one embodiment, the method further includes determining a signature for the value, wherein the value maps to the signature, and wherein the signature comprises fewer bits than the value, and storing the signature of the value in the entry of the storage array. In one embodiment, the method further includes computing a hash of the value, wherein the signature comprises a subset of bits of the hash. In one embodiment, prior to storing the value in the storage array, the method further includes evicting a different value from the storage array. In one embodiment, evicting the different value from the storage array includes determining that the different value is the least recently accessed value in the storage array, and evicting the different value in response to determining that the different value is the least recently accessed value. In one embodiment, evicting the different value from the storage array involves determining that the different value has a lowest reference count in the storage array, and evicting the different value in response to determining that the different value has the lowest reference count. In one embodiment, evicting the different value from the storage array involves determining that the different value is classified as low use relative to other values in the storage array, and evicting the different value in response to determining that the different value is classified as low use. In one such embodiment, values of the storage array are classified in one of a plurality of categories based on usage of the values.

In one embodiment, the storage array comprises one of a direct mapped cache, a set-associative cache, or a fully associative cache. In one embodiment, tracking the values within the window of requests involves in response to a first access to a given value within the window of requests, storing a tag or signature of the given value in the storage array without storing the entire given value, and in response to a second access to the given value within the window of requests, storing the entire given value and updating a corresponding status field to indicate the entry is valid. In one embodiment, in response to determining the given value is stored at a location in the searchable memory, the method further involves mapping a memory address associated with a request for the given value to the location in the searchable memory. In one embodiment, in response to determining the given value is not stored in the searchable memory, the method further involves storing the value at a location in the searchable memory and mapping a memory address associated with a request for the given value to the location in the searchable memory.

Flow diagrams as illustrated herein provide examples of sequences of various process actions. The flow diagrams can indicate operations to be executed by a software or firmware routine, as well as physical operations. In one embodiment, a flow diagram can illustrate the state of a finite state machine (FSM), which can be implemented in hardware and/or software. Although shown in a particular sequence or order, unless otherwise specified, the order of the actions can be modified. Additionally, a given operation can include sub-operations, or be combined with one or more other operations. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

To the extent various operations or functions are described herein, they can be described or defined as software code, instructions, configuration, and/or data. The content can be directly executable (“object” or “executable” form), source code, or difference code (“delta” or “patch” code). The software content of the embodiments described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. A circuit comprising:
interface circuitry to receive memory requests from a processor;
hardware logic to determine that a number of the memory requests that are to access a value meets or exceeds a threshold; and
a storage array to store the value in an entry based on a determination that the number meets or exceeds the threshold;
wherein, in response to receipt of a memory request from the processor to access the value at a memory address, the hardware logic is to map the memory address to the entry of the storage array.

2. The circuit of claim 1, wherein:
the hardware logic is to further update a reference count for the entry to indicate a number of memory addresses mapped to the entry.

3. The circuit of claim 2, wherein:
in response to the map of the memory address to the entry, the hardware logic is to increment the reference count; and
in response to detection of a subsequent request to write a different value to the memory address, the hardware logic is to decrement the reference count.

4. The circuit of claim 1, further comprising:
a second storage array to store the memory address and an identifier for the entry of the storage array.

5. The circuit of claim 4, wherein:
the memory request comprises a read request; and
wherein the hardware logic to map the memory address to the entry is to read the value from the entry of the storage array.

6. The circuit of claim 5, wherein:
in response to receipt of the read request, the hardware logic is to determine that the memory address is in the second storage array;
wherein the hardware logic is to further read the identifier associated with the memory address in the second storage array; and
wherein the hardware logic is to read the value from the entry of the storage array based on the identifier.

7. The circuit of claim 4, wherein:
the memory request comprises a write request; and
wherein the hardware logic to map the memory address to the entry of the storage array is to, store, in the second storage array, the memory address and the identifier for the entry.

8. The circuit of claim 7, wherein:
in response to receipt of the write request, the hardware logic is to search for the value in the storage array; and
wherein the hardware logic is to map the memory address to the entry of the storage array based on a determination that the value is stored in the entry.

9. The circuit of claim 8, wherein:
the hardware logic to search for the value in the storage array is to:
determine a signature of the searched for value;
compare the signature of the searched for value with signatures stored in the storage array; and
in response to a matching signature, compare the searched for value with a value in the storage array corresponding to the matching signature.

10. The circuit of claim 1, wherein:
the hardware logic to determine that the number meets or exceeds the threshold is to:
track values within a window of requests; and
determine the value was requested more than once within the window of requests.

11. The circuit of claim 1, wherein:
the hardware logic to determine that the number meets or exceeds the threshold is to:
track values within a window of time; and
determine the value was requested more than once within the window of time.

13. The circuit of claim 1, further comprising:
a buffer to store signatures of values to be written by write requests within a window;
wherein the hardware logic is to compare the signatures in the buffer to determine whether the number meets or exceeds the threshold.

14. The circuit of claim 13, wherein:
the buffer is to store identifiers for entries of the storage array to which read requests within the window are redirected to;
wherein the hardware logic is to compare the identifiers in the buffer to determine whether the number meets or exceeds the threshold.

15. The circuit of claim 2, wherein:
the hardware logic to determine that the number meets or exceeds the threshold is to:
track the reference count of the value in an entry of the storage array; and
determine the reference count meets or exceeds a threshold value.

16. The circuit of claim 1, wherein:
in response to a determination that a given value is not stored in the storage array, the interface circuitry is to send a given memory request that is to access the given value to searchable memory logic to search for the given value in a searchable memory.

17. A system comprising:
a processor; and
a circuit communicatively coupled with the processor, the circuit comprising:
interface circuitry to receive memory requests from the processor;
hardware logic to determine that a number of the memory requests that is to access a value meets or exceeds a threshold; and
a storage array to store the value in an entry based on a determination that the number meets or exceeds the threshold;
wherein, in response to receipt of a memory request from the processor to access the value at a memory address, the hardware logic is to map the memory address to the entry of the storage array.

18. The system of claim 17, further comprising: any of a display communicatively coupled to the processor, a network interface communicatively coupled to the processor, or a battery coupled to provide power to the system.

19. A method comprising:
receiving memory requests from a processor;
determining that a number of the memory requests that are to access a value meets or exceeds a threshold; and
storing the value in an entry of a storage array based on a determination that the number meets or exceeds the threshold;
wherein, in response to receiving a memory request from the processor to access the value at a memory address, mapping the memory address to the entry of the storage array.

20. The method of claim 19, further comprising:
updating a reference count for the entry to indicate a number of memory addresses mapped to the entry.
